(19) United States
(12) Patent Application Publication
(10) Pub. No.: US 2014/0091520 A1
(43) Pub. Date: Apr. 3, 2014

(54) Bonus Win System For Skill Games With PrizeDispenser

(71) Applicant: Clay T. Cacas, Terrell, TX (US)

(72) Inventor: Clay T. Cacas, Terrell, TX (US)

(21) Appl. No.: 13/628,887

(22) Filed: Sep. 28, 2012

(51) Int. Cl. G07F 17/32

(52) U.S. Cl. CPC G07F 17/3297
USPC 273/138.3

(57) ABSTRACT

A game apparatus is provided comprising a cabinet defining a playing area including a plurality of shelves mounted therein where each of the shelves has disposed thereon a plurality of game pieces. A receiving mechanism is attached to the cabinet for accepting a playing piece. A playing area with one or more holes that allow game pieces to fall through the playing area into a mechanism that counts the game pieces until the count is equal to a predetermined number and reward the player a prize or additional playing pieces depending on the operators adjustments.

### BACKGROUND OF INVENTION

This invention relates generally to amusement games and more particularly, relates to skill games refer to as Quarter pushers.

Amusement games in which coins are dropped onto a shelf traversed by pusher bars are well known. In such an arrangement the coins buildup on a shelf until the constant movement of the pusher bar causes coins to fall off a forward edge of the shelf as a reward. A further known device is a game apparatus comprising a cabinet defining a playing area, means for receiving a playing piece such as a token or the like, means for projecting playing piece within the playing area, and a sensor disposed within the playing area, which may be triggered by a projected playing piece. The sensor when actuated by contact causes the apparatus to register a predetermined reward. The device further includes a lower shelf surface onto which the playing pieces may fall after projection which includes a pusher for pushing the collected playing pieces from the shelf The latter device may be seen in U.S. Pat. No. 4,496,160 to Wichinsky et al.

Some amusement game reward the player with a prize which is dispensed by dropping it into a prize box for removal, this method limits the type of prizes offered.

While these devices work for their intended purpose, there exist a need for a novel amusement apparatus having new features whereby renewed interest by players of redemption type games will be generated.

An object of the present invention is to provide an improved game apparatus including a bonus that requires skill and chance and which, in the preferred embodiment, is combined with such known amusement apparatus.

It is another object of the present invention to provide a novel apparatus that will generate new interest in these amusement games in both games played with coins and with games played with tokens.

An object of the present invention is to provide an improved game apparatus in which one or more holes in the playfield will be in a arrangement that allows the game to operate as a traditional pusher, when none of the game pieces are push into the holes.

It is another objective of the present invention to provide a prize dispensing device that will award the player a prize and dispense it to the player, or dispense it to the playfield and the prize can be removed only in the event the prize has been won by the normal play of the game and is dispensed by the device.

### BRIEF SUMMARY OF THE INVENTION

In accordance with these objects, a game apparatus is provided comprising a cabinet defining a playing area including a plurality of shelves mounted therein where each of the shelves has disposed thereon a plurality of game pieces. A receiving mechanism is attached to the cabinet for accepting a playing piece. A playing area with one or more holes that allow game pieces to fall through the playing area, and to count the pieces for each hole as they drop through. Each hole rewards the player a prize when the number of pieces that have falling through a hole is equal to the number required to win the prize for that hole.

A better under standing of the objects, advantages, feature, properties and relationships of the invention will be obtained from the following detailed description and accompanying drawings which set forth an illustrative embodiment and is indicative of the various ways in which the principles of the invention may be employed.

### BRIEF DESCRIPTION OF THE DRAWINGS

FIG. 1 front view of present invention shown with preferred embodiment;

FIG. 2 side view of present invention shown with preferred embodiment;

FIG. 3 top view of playing area;

FIG. 4 Enlarged view of prize box;

FIG. 5 View of inside front;

FIG. 6 Front view of prize dispensing system;

FIG. 7 Bottom View of Drawer;

FIG. 8 View of Solenoid;

FIG. 9 Multiple views of game piece dispenser;

FIG. 10 Top view of game piece dispenser;

FIG. 11 Front view of game piece dispenser;

FIG. 12 Front inside view of game piece dispenser;

FIG. 13 Side view of game piece dispenser;

FIG. 14 Side view of game piece dispenser with attaching bar;

### DETAILED DESCRIPTION

While the inventions contained herein can be used in all types of amusement games it will be described hereinafter in the context of a bonus win system as the preferred embodiment thereof.

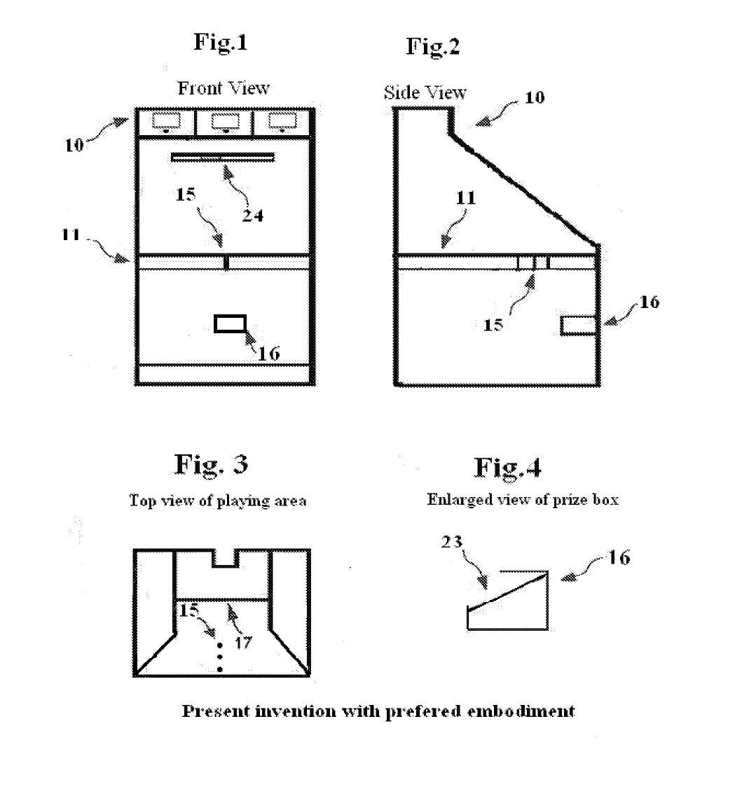

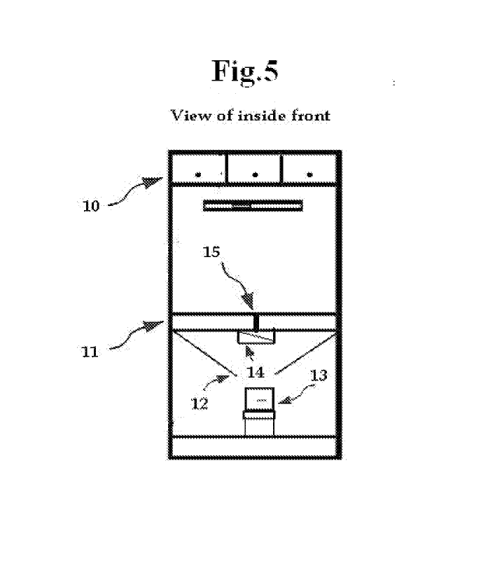

Referring now to the drawings, wherein like reference numerals refer to like elements, the front of the game apparatus is shown generally in FIG. 1. Generally comprises a cabinet containing a coin accepting and projecting mechanism (FIG. 1-24) a playing area where said playing area is comprised of two shelves (FIG. 3-11) and (FIG. 3-17) where one shelf (FIG. 3-17) transverses the playing area and where (FIG. 3-11) has one or more holes arranged linearly (FIG. 3-15) that allows some playing pieces to fall thru the playing area into a counting mechanism (FIG. 5-14), and then to a slide (FIG. 5-12) that returns the playing piece to the coin hopper (FIG. 5-13). The holes (FIG. 3-15) are arranged in a straight line, allowing the game to operate as a traditional pusher if a game piece does not fall in one of the holes. Game pieces are pushed off the edge where they fall in the prize box (FIG. 4-16) land on the prize box slide(FIG. 4-23) directing the pieces to the front of the prize box (FIG. 4-16) to be removed by the player.

The playing piece acceptor (FIG. 1-24) allows the player to control the position of the acceptor by sliding it in a right or left direction. The player inserts the playing pieces in the acceptor and then accelerated by gravity these pieces are projected on to the playing area (FIG. 3-17) The player uses skill to control the path of the pieces to influence the affect it will have on the other pieces.

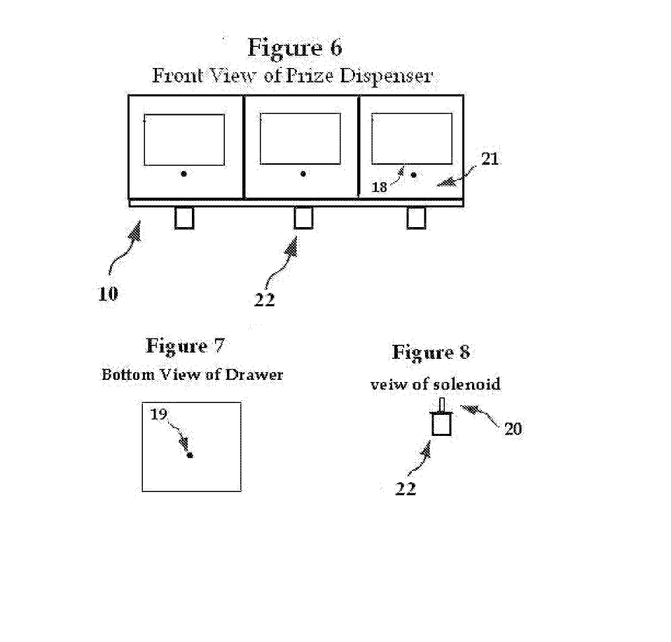

The Prize dispensing apparatus FIG. (6-10) is mounted over game piece acceptor. The dispensing apparatus has three drawers with viewing windows (FIG. 6-18). Prizes are placed in drawers that remain locked until that prize has been won. The drawer is locked by a solenoid FIG. (8-22) that has a metal rod (FIG. 8-20) that sits on a spring inside the solenoid. The spring pushes the rod into a hole (FIG. 7-19) on the bottom of the drawer. When a prize is won the solenoid is activated and the rod is pulled down, allowing the drawer to be opened and the prize removed.

The prize dispensing apparatus is interfaced with a control board which will operate the solenoid and unlock the drawer to reward players with different types of prizes.

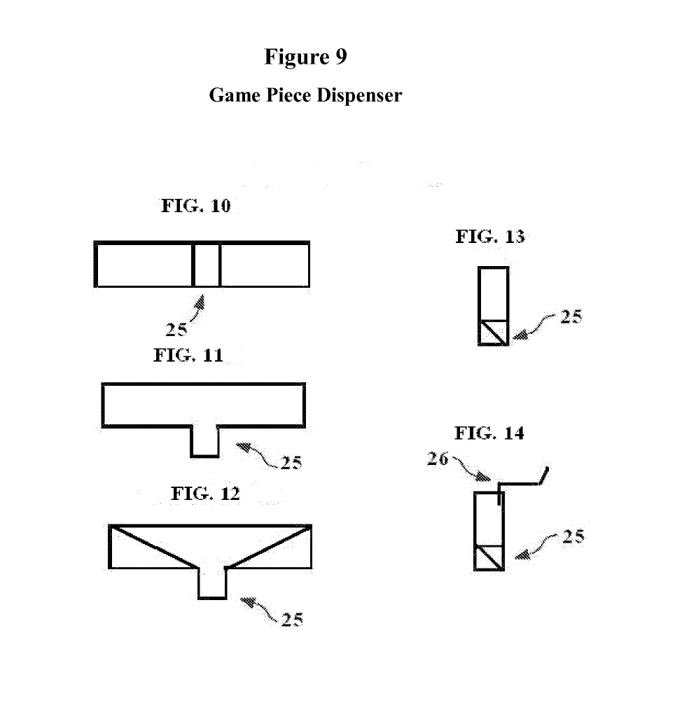

A game piece dispensing apparatus (FIG. 9) dispenses awarded game pieces won by the player. This apparatus would be attached to the playing piece acceptor inside the game, to let the player control the placement of the awarded pieces, with the attachment bar (FIG. 9-26). The game piece slide (FIG. 9-25) would put the pieces into play.

It should be apparent from the preceding description that this invention has among other advantages, the advantage of providing a unique skill game capable of variable play through operator adjustments.

While specific embodiments of the invention have been described in detail, it will be known by those skilled in the art that various modifications and alternatives to those details could be developed in the light of the overall teachings of the disclosure. Accordingly, the particular arrangements disclosed are meant to be illustrative only and not limiting as to the scope of the invention which is to be given the full breadth of the appended claims and any equivalent thereof.

What is claimed is:

1. A game apparatus comprising a cabinet defining a playing area, means for receiving and accepting or rejecting a playing piece such as a coin or token, means for projecting an accepted playing piece within the playing area, and at least one shelf disposed in a lower portion of the playing area and onto which projected playing pieces may fall after projection, with said playing area containing one or more holes placed in liner path from front edge to the back of the playfield, bisecting the playfield, that allows playing pieces to fall through and activate a prize dispensing apparatus with one or more drawers that remained locked, by a spring held metal rod from a solenoid fitted into a hole in the bottom of each drawer, until the prize is won and the solenoid is activated and the rod is pulled out of the hole unlocking the drawer allowing the drawer to open and the prize be removed, rewarding the player a prize when the desired number of fallen playing pieces have been registered, and said shelf being traversed by pusher means which push playing pieces collected thereon towards an edge of the shelf.

2. A game apparatus comprising a cabinet defining a playing area, means for receiving and accepting or rejecting a playing piece such as a coin or token, means for projecting an accepted playing piece within the playing area, and at least one shelf disposed in a lower portion of the playing area and onto which projected playing pieces may fall after projection, with said playing area containing one or more holes placed in liner path from front edge to the back of the playfield, bisecting the playfield, that allows playing pieces to fall through, and activate a playing piece dispensing apparatus comprising of an rectangular box having two flat inserts that direct game pieces down toward an angular coin slide at the middle base of said box that dispenses game pieces onto the play field, a ridged bar connects said box to the coin chute allowing the player to direct the placement of awarded game pieces when the desired number of fallen playing pieces have been registered, and said shelf being traversed by pusher means which push playing pieces collected thereon towards an edge of the shelf.
